(19) United States
(12) Patent Application Publication
(10) Pub. No.: US 2026/0113274 A1
(43) Pub. Date: Apr. 23, 2026

(54) OPTIMIZING TREE-BASED COLLECTIVE COMMUNICATION OPERATIONS BY LOAD-BALANCING NETWORK ENDPOINTS

(71) Applicant: Microsoft Technology Licensing, LLC, Redmond, WA (US)

(72) Inventors: Mohammad Saifee DOHADWALA, Kirkland, WA (US); Daniel SANTOS FERREIRA ALVES, Mountain View, CA (US); Michael Konstantinos PAPAMICHAEL, Redmond, WA (US); David Andreas SIDLER, Seattle, WA (US); Zhipeng ZHAO, Kirkland, WA (US)

(21) Appl. No.: 18/922,388

(22) Filed: Oct. 22, 2024

(51) Int. Cl. H04L 47/125; H04L 45/02

(52) U.S. Cl. CPC H04L 47/125; H04L 45/02

(57) ABSTRACT

The present disclosure generally relates to optimizing load-balancing of network endpoints using tree collectives representing a logical network communication topology for the network endpoints. Systems and methods described herein eliminate the previously restrictive conditions imposed on tree-based communication collectives by generating collective trees with any arity and representing any number of physical network endpoints. The resulting collective trees ensure that each represented network endpoint has a number of outgoing flows and a number of incoming flows that are no more than the arity of the collective tree. In this way, the described systems and methods inject significant efficiencies into communication collectives within networked compute nodes by eliminating communication bandwidth latencies and bottlenecks.

### BACKGROUND

Large-scale distributed workloads such as High-Performance Computing (HPC) and Artificial Intelligence (AI) generally utilize extensive communication among compute nodes. As such, performance of these complex systems regularly depends on the efficiency of those communications. Often, communication patterns (e.g., “collectives”) happen in a synchronized manner across multiple participants in such distributed systems.

In many examples, communication patterns or collectives can be implemented according to various algorithms. For example, a ring-based algorithm or a tree-based algorithm are often implemented to carry out certain collectives among networked compute nodes. To illustrate, in a ring-based approach, all compute nodes are logically connected as a ring, where one node only communicates with its two neighbors. As such, it takes N−1 steps to broadcast data among N nodes in the ring-based approach.

In a tree-based approach, nodes are logically constructed as a tree, where a root node communicates with its children nodes, who then communicate with their own children nodes, and so on. For a binary tree, where a parent node has two children nodes, it takes Log 2(N) steps to communicate data to all nodes in the tree. In modern large-scale AI training systems, for example, the number of nodes involved in a collective is large. As such, a tree-based approach generally has significant latency advantages over a ring-based approach.

Despite this, using a single tree for a collective can result in inefficient utilization of network bandwidth. For example, compute nodes within a distributed system are often networked with a network switch, where the bandwidth of uplinks (e.g., a compute node sends data up to the switch, which then forwards the data to its destination node) and downlinks (e.g., the network switch forwards data from a source node to its destination node) are symmetric. However, an intermediate parent node within a logical tree representing the physical compute nodes receives data from its own parent node, but then needs to forward the data to children nodes. As such, this intermediate node will often receive one times the data on its downlink (i.e., has one incoming flow), while sending two times the data on its uplink (i.e., has two outgoing flows). Thus, when this intermediate node's uplink is fully utilized, half of its downlink is idle—resulting in network inefficiency.

In an attempt to remedy this inefficiency, some systems have leveraged Double Binary Trees. For example, a Double Binary Tree introduces another logical tree to a single binary tree, such that two logical trees are built complementary to each other with the node indexes interleaved. This approach, however, relies on a narrow set of specific conditions in order to optimally utilize the double tree, and is not a realistic approach for many network systems.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### BRIEF DESCRIPTION OF THE DRAWINGS

FIGS. 1A and 1B illustrates an example network environment including a tree-based collective optimization system in accordance with one or more embodiments.

FIG. 2 illustrates an example series of acts for generating a logical ring-based collective tree that optimally load-balances physical network endpoints in accordance with one or more embodiments.

FIGS. 3A-3G illustrate an example embodiment of the tree-based collective optimization system generating a collective tree in accordance with one or more embodiments.

FIG. 4 illustrates a block diagram of the tree-based collective optimization system in accordance with one or more embodiments.

FIG. 5 illustrates certain components that may be included within a computer system.

### DETAILED DESCRIPTION

The present disclosure relates to systems, methods, and computer-readable media for optimizing load-balancing of network endpoints using tree collectives representing a logical network communication topology for the network endpoints. As discussed above, existing systems utilize tree-based collectives under limited conditions. More specifically, existing systems limit the use of tree-based collectives to a given number of network endpoints. In practice, this is overly limiting because real-world systems configurations generally have a wide variety of network endpoints. As such, tree-based collectives are inefficiently utilized because realistic system configurations often fail to line up with the limits on these types of collectives imposed by previous systems. Thus, many collectives are implemented using a ring-based approach—leading to various inefficiencies and resource bottlenecks.

In light of this, the present disclosure describes a tree-based collective optimization system that fully leverages the efficiencies of tree-based collectives with any number of nodes and any tree-based arity to load-balance network endpoints. In one or more embodiments, and as will be discussed in greater detail below, the tree-based collective optimization system constructs a collective tree—for any number of nodes N and any arity k of the tree—such that any node in the collective tree will have at most k incoming flows and at most k outgoing flows. When mapped to physical network endpoints, the fully-balanced logical tree generated by the tree-based collective optimization system improves efficiency of network endpoint uplink and downlink utilization.

As mentioned above, the tree-based collective optimization system significantly improves the efficiency of networked compute nodes by ensuring the uplink and downlink capabilities of those compute nodes are balanced. For example, as discussed above, networked collectives are often logically implemented with a ring-based approach where one node communicates only with its two neighbors. As such, the number of steps required to broadcast among N nodes is N−1—leading to a runtime of O(N). Implementing collectives utilizing a tree-based approach is acknowledged to be much more efficient (i.e., O(Log(N)) runtime). Despite this, as discussed above, the tree-based approach is infrequently utilized because of the limits it places on a number of physical compute nodes and tree arity.

The tree-based collective optimization system utilizes a novel approach for generating logical collective trees that removes these limitations and allows for collective trees to be implemented with any number of nodes and any arity. Thus, the logical collective tree generated by the tree-based collective optimization system allows for a switch with networked nodes in a typical hierarchical fat-tree physical topology to perform optimally with less latency and fewer bottlenecks than experienced by ring-based collectives. For example, the tree-based collective optimization system generates collective trees that ensure runtimes of O(Logₖ(N)) for communication collectives operating across a switch with networked nodes, where k is the arity of the collective tree and N is the number of nodes. This represents a significant runtime improvement over the more commonly implemented ring-based approach discussed above.

In one or more implementations, the methods and steps performed by the tree-based collective optimization system reference multiple terms. For example, as referenced herein, a “network switch” refers to a device that connects multiple devices within a network and manages the flow of data between them. As further referenced herein, a “physical compute node” refers to such a device that is connected to a network switch. In one or more embodiments, a network endpoint is one such physical compute node that connects within a network. In one or more embodiments, and as will be discussed in greater detail below, devices can connect to a network switch via uplinks and downlinks.

As referred to herein, a “collective” or “communication collective” refers to an exchange of data among nodes. For example, in high-performance computing environments, tasks are often distributed across compute nodes to improve efficiency and performance. Thus, a communication collective can dictate how information moves among those nodes prior to, during, or following completion of those tasks. As discussed in greater detail below, some examples or communication collectives can include a broadcast collective, a reduce collective, and an all reduce collective.

As used herein, a “tree” refers to a hierarchical data structure. In one or more embodiments, a tree includes a root node (e.g., a topmost node with no parent), parent nodes, child nodes, leaf nodes (e.g., nodes with no children), and edges representing connections between parent nodes, child nodes, and/or leaf nodes. A tree can have multiple subtrees. Moreover, as used herein, the “arity” of a tree refers to the number of children each node in the tree can have (k). For example, a binary tree has an arity of 2 meaning each node has at most two children. Collective trees such as discussed herein can be n-ary trees meaning each node can have up to (n) children.

As used herein, a “breadth-first search subtree” refers to a subtree that is constructed in a breadth-first manner. For example, and as will be discussed in greater detail below, a breadth-first search subtree is constructed by queuing all nodes in order and constructing the tree such that a first node is assigned k (i.e., the arity of the subtree) children. Then the first child of the first node is assigned k children, then the second child of the first node is assigned k children, and so forth until no nodes remain in the queue.

As used herein, a “logical network communication topology” refers to an abstract representation of how data flows within a network, regardless of the physical layout of that network. As will be illustrated in greater detail below, a network switch may be connected to a number of network endpoints in a typical fat-tree physical topology. Despite this, a logical network communication topology may be applied to those physical nodes that define a different flow of data than that commonly utilized as part of the physical topology.

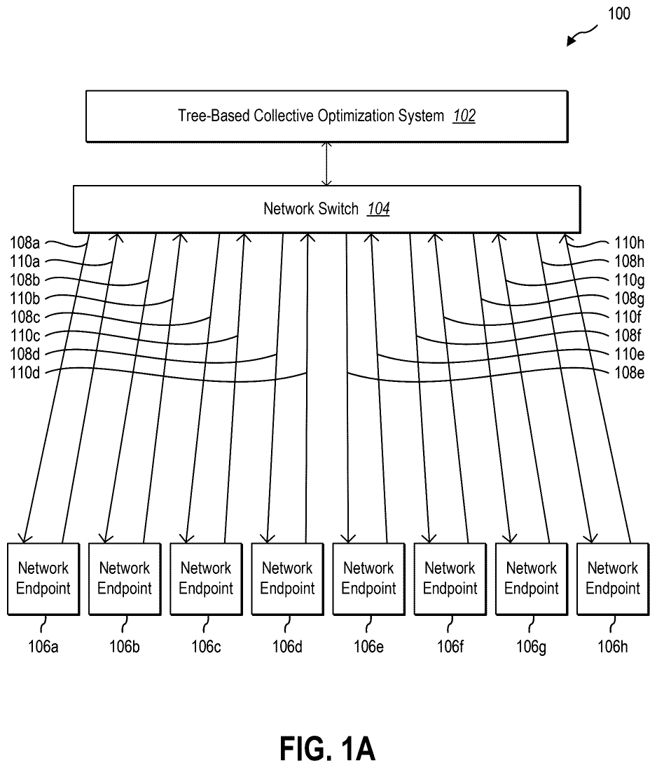

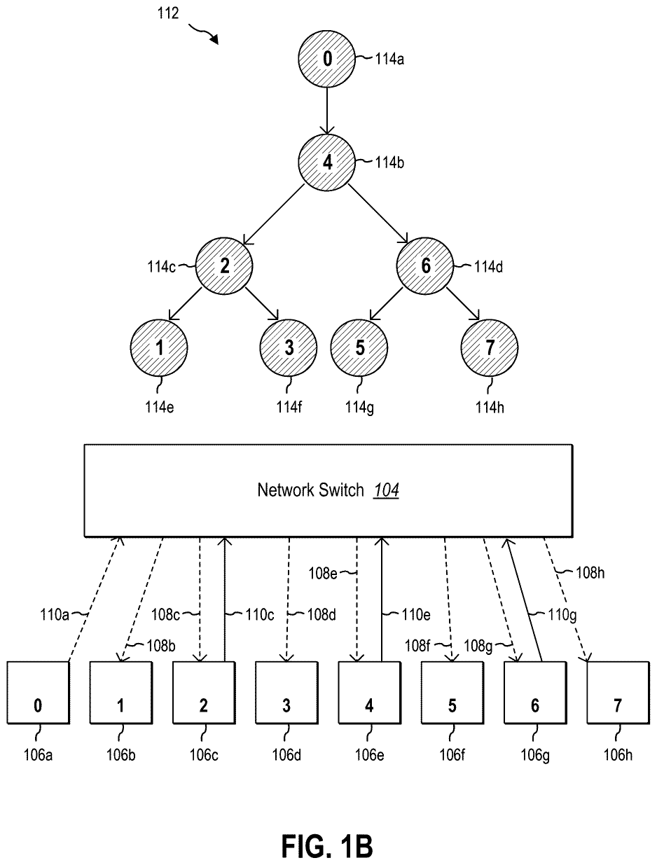

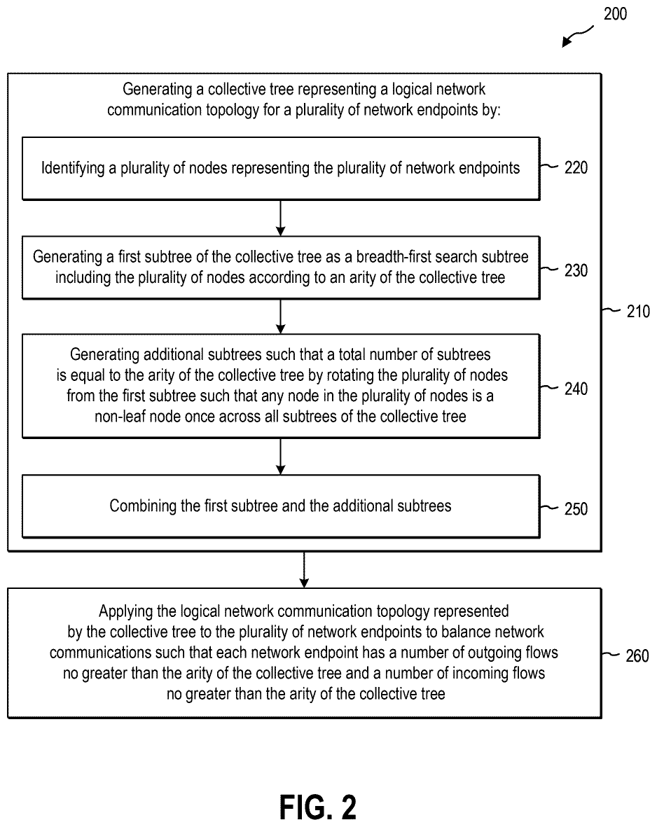

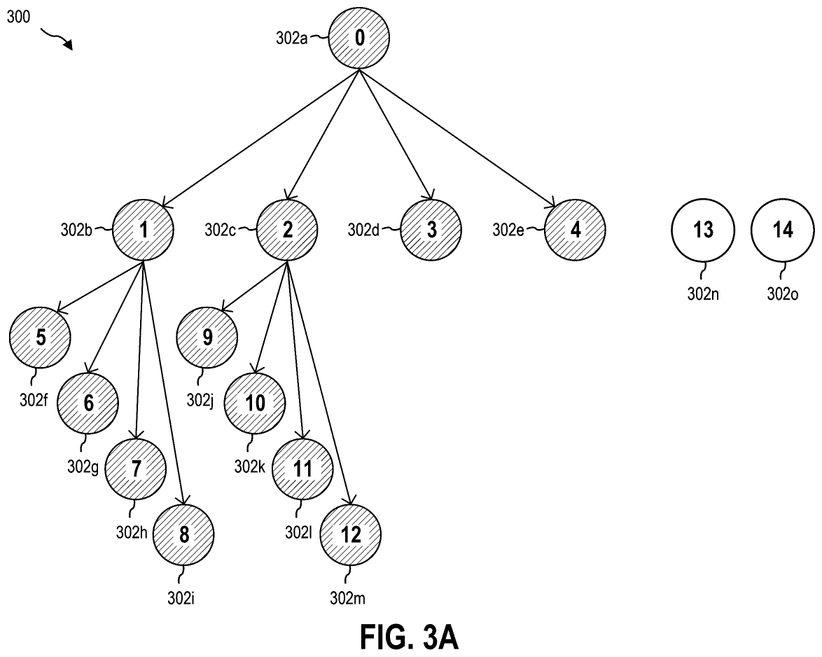

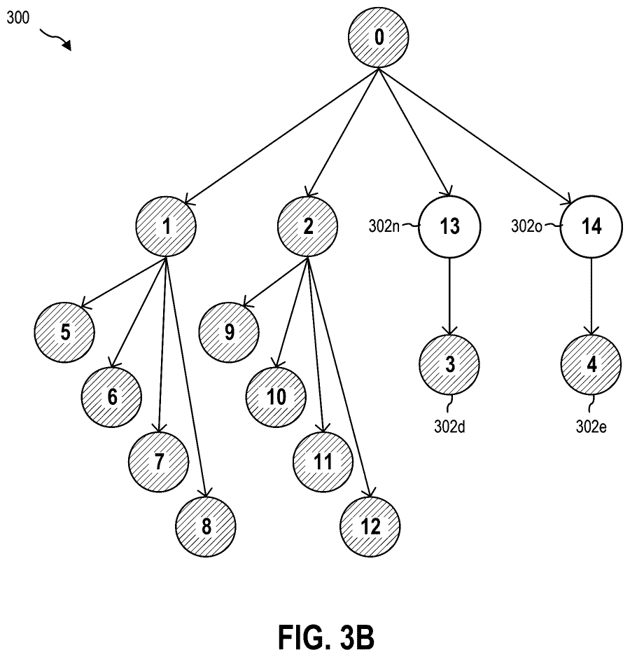

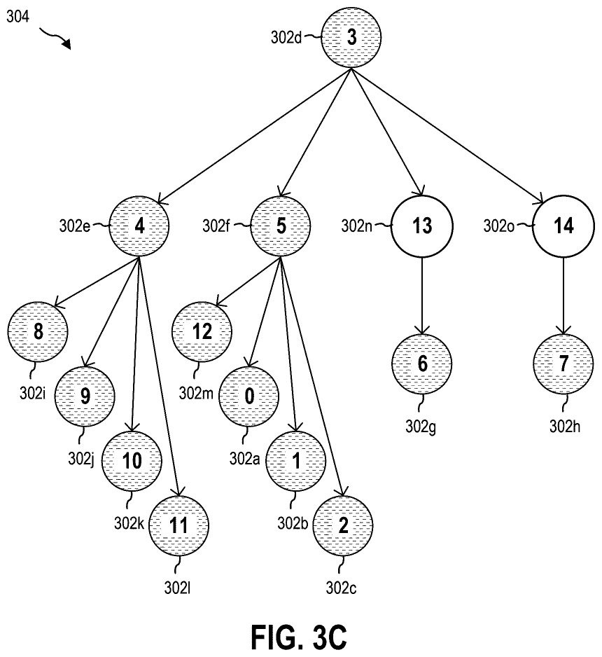

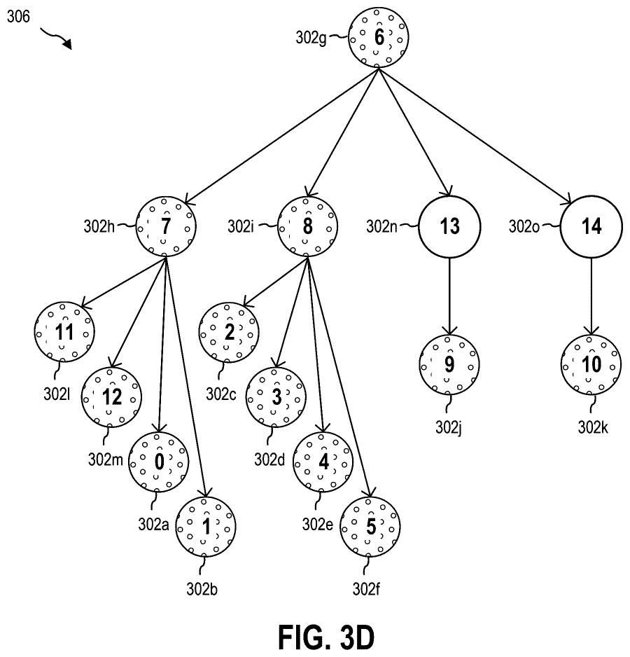

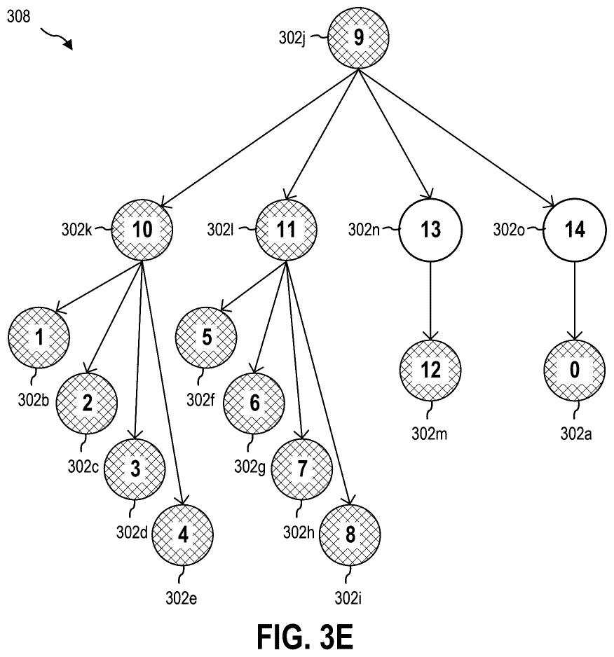

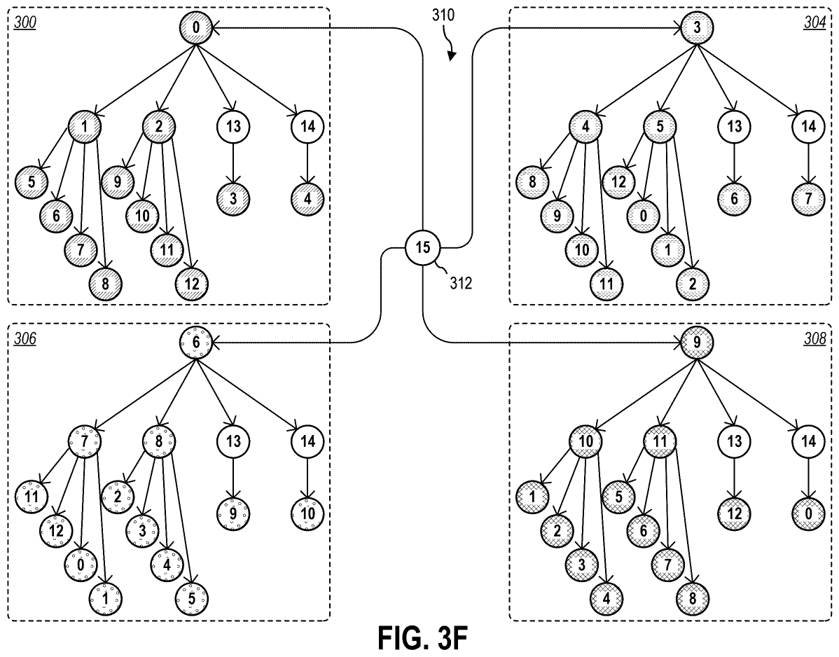

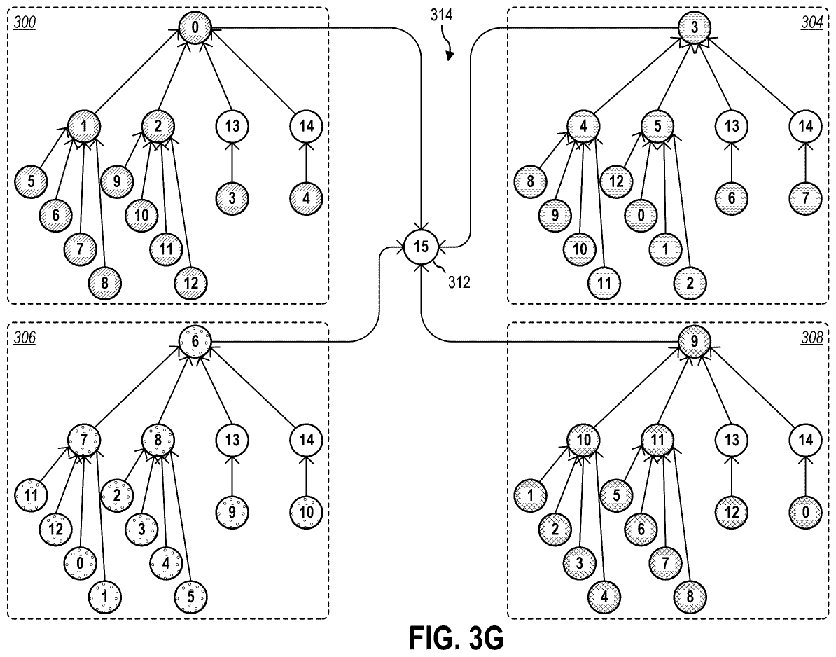

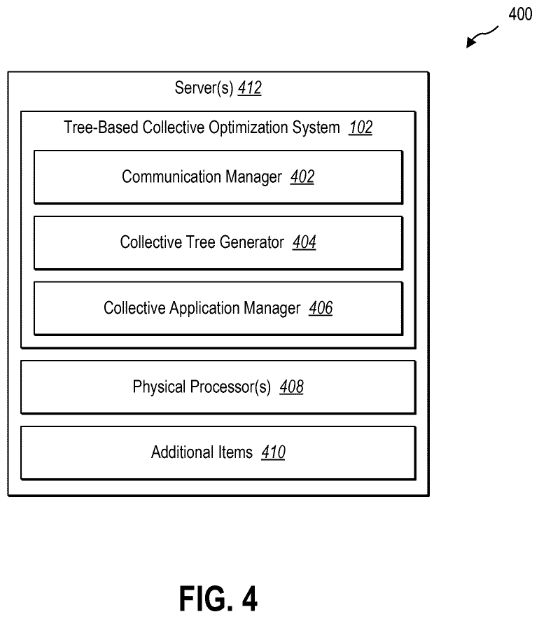

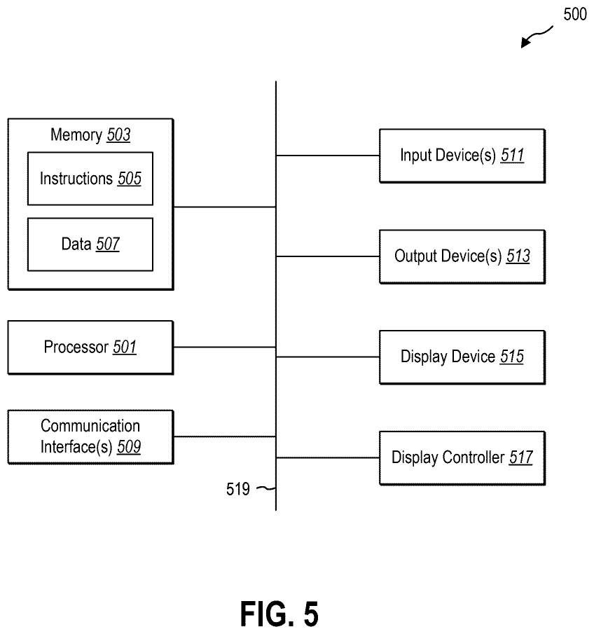

Additional details regarding example implementations of the tree-based collective optimization system will now be discussed in connection with the following figures. To illustrate, FIG. 1A provides an example overview of a networked environment where the tree-based collective optimization system operates to optimally load-balance network endpoints. FIG. 1B illustrates additional detail in connection with logical topologies and physical topologies. FIG. 2 illustrates a series of acts for generating a logical collective tree that optimally load-balances physical network endpoints. FIGS. 3A-3G illustrate how the tree-based collective optimization system generates a logical collective tree that can be applied to physical network endpoints. FIG. 4 illustrates a schematic diagram of the features and functionality of the tree-based collective optimization system. Finally, FIG. 5 illustrates an overview diagram of a computing system.

As just mentioned, FIG. 1A illustrates an example overview of an environment 100 including a tree-based collective optimization system 102 operating in connection with network switch 104. In the example shown in FIG. 1A, the network switch 104 is connected to network endpoints 106a, 106b, 106c, 106d, 106e, 106f, 106g, and 106h in a hierarchical fat-tree physical topology. While FIG. 1A shows example arrangements and configurations including the tree-based collective optimization system 102, other arrangements and configurations are possible.

As shown in FIG. 1A, the network switch 104 is connected to the network endpoints 106a-106h by a series of links. For example, the network switch 104 can communicate or transmit data to each of the network endpoints 106a-106h via downlinks 108a, 108b, 108c, 108d, 108e, 108f, 108g, and 108h, respectively. Additionally, each of the network endpoints 106a-106h can communicate or transmit data to the network switch 104 via uplinks 110a, 110b, 110c, 110d, 110e, 110f, 110g, and 110h, respectively. As such, the network switch 104 is in a centralized position to communicate data among the network endpoints 106a-106h for the purpose of one or more collectives, or communication patterns that happen in a synchronized manner across the endpoints 106a-106h.

As mentioned above, FIG. 1A illustrates a physical network switch 104 with physical connections to physical network endpoints 106a-106h. In one or more embodiments, the tree-based collective optimization system 102 generates logical collective trees that dictate a logical communication topology. The tree-based collective optimization system 102 further applies this logical communication topology onto the physical network switch 104 and network endpoints 106a-106h to instruct those machines how to communicate with each other. By applying the logical communication topology indicated by the tree-based collectives, the tree-based collective optimization system 102 causes the network switch 104 and network endpoints 106a-106h to optimally utilize their computing resources in a balanced way.

In one or more embodiments, the tree-based collective optimization system 102 runs on a separate computer from the network switch 104. For example, the tree-based collective optimization system 102 can configure the network endpoints 106a-106h through one or more out-of-band channels to set up tree-based collectives and facilitate logical communication flows. To illustrate, the tree-based collective optimization system 102 can configure the flow between network endpoints 106a and 106b by instructing the network endpoint 106a that its destination IP internet protocol address (IP address) is the network endpoint 106b, and by instructing the network endpoint 106b that its source IP address is the network endpoint 106a. Later, when collective communication starts, each network endpoint runs independently by following these pre-configured flows to communication with their destinations. The network switch 104 forwards packets to the right ports/links based on these pre-configured IP addresses.

In more detail, FIG. 1B illustrates how a previous system may map a logical tree 112 onto the network switch 104 and network endpoints 106a-106h. For example, the logical tree 112 is a binary tree where each node, except the root node 114a and the leaf nodes 114e, 114f, 114g, and 114h, has two children. When utilized as a broadcast collective, the root node 114a transmits data to the node 114b, which then transmits that data to the nodes 114c and 114d. Each of the nodes 114c, 114d transmit that data to their children nodes 114e, 114f, and 114g, 114h, respectively.

In one or more embodiments, the logical tree 112 represents logical communication instructions for how the network endpoints 106a-106h communicate with each other via the network switch 104. For example, as further shown in FIG. 1B, the logical tree 112 can be mapped to the uplinks and downlinks between the network endpoints 106a-106h and the network switch 104.

To demonstrate, the node 114b in the logical tree 112 (e.g., node 4) is mapped to the network endpoint 106e. Thus, as the node 114b sends data to two nodes (e.g., the nodes 114c, 114d) but receives data from only one node (e.g., the root node 114a), the network endpoints 106e utilizes twice as much bandwidth on its uplink 110e (e.g., indicated by the double line) as on its downlink 108e. This illustrates how the logical tree 112 leads to imbalance and inefficiency when mapped to physical network endpoints.

The tree-based collective optimization system 102 remedies these issues by generating a collective tree with any arity representing a logical network communication topology for any number of network endpoints. For example, as mentioned above, FIG. 2 illustrates an example series of acts 200 for optimizing load-balancing of any number of physical network endpoints with a collective tree. While FIG. 2 illustrates acts according to one or more embodiments, alternative embodiments may omit, add to, reorder, and/or modify any of the acts shown in FIG. 2. The acts of FIG. 2 can be performed as part of a method. Alternatively, a non-transitory computer-readable medium can include instructions that, when executed by one or more processors, cause a computing device to perform the acts of FIG. 2. In still further embodiments, a system can perform the acts of FIG. 2.

As illustrated in FIG. 2, the series of acts 200 includes an act 210 of generating a collective tree representing a logical network communication topology for a plurality of network endpoints. For example, the series of acts 200 includes generating a collective tree representing a logical network communication topology for a plurality of network endpoints by performing several additional acts. To illustrate, the series of acts 200 includes generating a collective tree representing a logical network communication topology for a plurality of network endpoints according to the act 220 of identifying a plurality of nodes representing the plurality of network endpoints, the act 230 of generating a first subtree of the collective tree as a breadth-first search subtree including the plurality of nodes according to an arity of the collective tree, the act 240 of generating additional subtrees such that a total number of subtrees is equal to the arity of the collective tree by rotating the plurality of nodes from the first subtree such that any node in the plurality of nodes is a non-leaf node once across all subtrees of the collective tree, and the act 250 of combining the first subtree and the additional subtrees.

In one or more embodiments, the series of acts 200 further includes generating the collective tree further by, prior to generating the first subtree and the additional subtrees, setting aside a subset of the plurality of nodes based on the arity of the collective tree. Moreover, in some embodiments, the series of acts 200 also includes generating the collective tree further by, while generating the first subtree and the additional subtrees, inserting the subset of the plurality of nodes back into the first subtree and the additional subtrees by replacing existing leaves in the first subtree and the additional subtrees with the subset of the plurality of nodes and adding any replaced leaves back into the first subtree and the additional subtrees as children of the subset of the plurality of nodes.

In at least one embodiment, the series of acts 200 includes generating the collective tree by: identifying a root node from the plurality of nodes based on a type of the collective tree, excluding the root node from generating the first subtree and the additional subtrees, wherein combining the first subtree and the additional subtrees utilizes the root node. For example, the type of the collective tree can include a reduce collective and/or a broadcast collective.

As further shown in FIG. 2, the series of acts 200 includes an act 260 of applying the logical network communication topology represented by the collective tree to the plurality of network endpoints to balance network communications such that each network endpoint has a number of outgoing flows no greater than the arity of the collective tree and a number of incoming flows no greater than the arity of the collective tree. Thus, in one or more embodiments, a number of steps to complete a collective among the plurality of network endpoints after the logical network communication topology represented by the collective tree is applied includes two times a logarithm of a number of the plurality of network endpoints. In at least one embodiment, the arity of the collective tree is user-defined.

As discussed above, the tree-based collective optimization system 102 generates collective trees representing logical network communication topologies for network endpoints. These communication topologies instruct the network endpoints how to communicate among themselves to accomplish collective goals. For example, as mentioned above, during a reduce collective, the communication topology represented by a collective tree generated by the tree-based collective optimization system 102 instructs network endpoints (e.g., physical compute nodes) to communicate a piece of data to a single node (e.g., a root node) such that all of the collected pieces of data can be combined into a single result. In another example, during a broadcast collective, the communication topology represented by a collective tree generated by the tree-based collective optimization system 102 instructs network endpoints to communicate a single piece of data among themselves from a root node.

In one or more embodiments, the tree-based collective optimization system 102 improves existing systems methods of generating collective trees by removing the overly-restrictive configuration requirements common to existing systems. While previous collective trees could only be generated within a narrow range of nodes and arities, the tree-based collective optimization system 102 generates collective trees with any number of nodes (i.e., representing physical network endpoints) and any arity, where any node has—at most—a number of incoming and outgoing flows equal to the arity. As such, the collective trees generated by the tree-based collective optimization system 102 can be utilized in a variety of network system configurations to provide significant latency advantages over the more common ring-based collective approaches. FIGS. 3A-3G illustrate one example implementation of the tree-based collective optimization system 102 generating a collective tree according to this novel approach. Other implementations may have different numbers of nodes having different arities. Thus, it will be appreciated that features and functionality described in connection with the example(s) shown in FIGS. 3A-3G may be applicable to other varieties of collective trees in accordance with one or more embodiments described herein.

For example, as shown in FIG. 3A, the tree-based collective optimization system 102 begins building a full collective tree by first building an initial subtree 300. As mentioned above, the tree-based collective optimization system 102 can build a collective tree for any number of nodes such that each subtree (e.g., such as the initial subtree 300) includes the number of nodes (N) with an arity (k). For some collectives, such as broadcast collectives and reduce collectives, the tree-based collective optimization system 102 sets a root node (e.g., a sixteenth node, not shown in FIG. 3A) aside and excludes this root node from the building of subtrees.

In constructing the initial subtree 300, the tree-based collective optimization system 102 first sets aside zero or more p-nodes (e.g., nodes 302n and 302o). For example, in one or more embodiments, the tree-based collective optimization system 102 sets aside p=(N−1) mod k nodes as p-nodes. In at least one embodiment, the p-nodes (e.g., the nodes 302n, 302o) represent nodes that would cause the initial subtree 300 to fail the indicated arity (k) if included in the initial construction of the initial subtree 300.

Next, the tree-based collective optimization system 102 builds the initial subtree 300 with the remaining nodes 302a, 302b, 302c, 302d, 302e, 302f, 302g, 302h, 302i, 302j, 302k, 302l, and 302m. In one or more embodiments, the tree-based collective optimization system 102 builds the initial subtree 300 as a full k-ary subtree using breadth-first search (BFS). To illustrate, the tree-based collective optimization system 102 orders all of the nodes 302a-302m and adds the first node (e.g., the node 302a) to the initial subtree 300 as its subtree root. The tree-based collective optimization system 102 then adds the next k nodes (e.g., the nodes 302b, 302c, 302d, and 302e) that are not in the initial subtree 300 as children of the subtree root node 302a. The tree-based collective optimization system 102 repeats this process by adding the next k nodes (e.g., the nodes 302f, 302g, 302h, 302i) as children of node 302b (e.g., the first node after the subtree root node 302a). The tree-based collective optimization system 102 continues by adding the next k nodes (e.g., the nodes 302j, 302k, 302l, 302m) as children of node 302c (e.g., the second node after the subtree root node 302a). At this point, the tree-based collective optimization system 102 has built a full k-ary subtree 300 because the p-nodes 302n and 302o were initially removed as they would have caused the last node with children to have less than k nodes.

At this point, the tree-based collective optimization system 102 can add the previously removed p-nodes 302n, 302o back into the initial subtree 300. For example, as shown in FIG. 3B, the tree-based collective optimization system 102 adds the p-nodes 302n, 302o back into the initial subtree 300 by identifying the same number of leaves (e.g., the nodes 302d, 302e) that are as close to the root as possible and removing them. The tree-based collective optimization system 102 then adds the p-nodes 302n, 302o to the initial subtree 300 in the positions previously occupied by the identified leaves (e.g., the nodes 302d, 302e). Finally, the tree-based collective optimization system 102 adds the now-removed nodes 302d, 302e back into the initial subtree 300 as children of the now-added p-nodes 302n, 302o. At this point, the initial subtree 300 is complete.

In one or more embodiments, the tree-based collective optimization system 102 generates a full collective tree including a number of subtrees, where the number of subtrees matches the given arity (k) of each subtree. In the example illustrated through FIGS. 3A-3G, the given arity (k) is four. As such, the tree-based collective optimization system 102 generates an additional three subtrees beyond the initial subtree 300 such that the total number of subtrees in the eventual collection tree is equal to the given arity (k). To generate each additional subtree, the tree-based collective optimization system 102 rotates the first N-p nodes from the initial subtree so that the node with index r_{old} is replaced by the node with index r_{new}=r_{old}+i*(N−1)mod k, where i is the index of the additional subtree starting from 1.

To illustrate, FIG. 3C shows a second subtree 304 generated by the tree-based collective optimization system 102 from the initial subtree 300. For example, the tree-based collective optimization system 102 generates the second subtree 304 by rotating the node index of the initial subtree 300 by 3 with a circular range of 12. As further shown in FIG. 3D, the tree-based collective optimization system 102 generates the third subtree 306 by rotating the node index of the initial subtree 300 by 6 with a circular range of 12. Finally, as shown in FIG. 3E, the tree-based collective optimization system 102 generates the fourth subtree 308 by rotating the node index of the initial subtree 300 by 9 with a circular range of 12.

At this point, all subtrees 300, 304, 306, and 308 are built for N−1 nodes. As mentioned above, for collectives such as reduce and broadcast, the tree-based collective optimization system 102 withholds the root node and constructs the needed subtrees with the remaining N−1 nodes. As shown in FIG. 3F, the tree-based collective optimization system 102 then generates a full collective tree 310 by connecting the root node 312 as the parent of the subtrees 300, 304, 306, and 308. In one or more embodiments, the full collective tree 310 is a broadcast collective where the root node 312 communicates data to the other represented nodes (e.g., as indicated by the directional communication arrows). As shown in FIG. 3G, the tree-based collective optimization system 102 can similarly generate the full collective tree 314 as a reduce collective with the represented nodes communicating data back to the root node 312 (e.g., as indicated by the directional communication arrows).

As mentioned above, and as shown in FIG. 4, the tree-based collective optimization system 102 optimizes network endpoint load-balancing for a variety of collectives by generating collective trees representing logical network communication topologies for those network endpoints. FIG. 4 is a block diagram 400 of the tree-based collective optimization system 102 operating within one or more memories of the server(s) 412 while load-balancing network endpoints (e.g., the network endpoints 106a-106h shown in FIGS. 1A and 1B) connected to the network switch 104. As such, FIG. 4 provides additional detail with regard to these functions. For example, as shown in FIG. 4, the tree-based collective optimization system 102 can include a communication manager 402, a collective tree generator 404, and a collective application manager 406.

In certain implementations, the tree-based collective optimization system 102 may represent one or more software applications, modules, or programs that, when executed by a computing device, may cause the computing device to perform one or more tasks. For example, and as will be described in greater detail below, one or more of the communication manager 402, the collective tree generator 404, and the collective application manager 406 may represent software stored and configured to run on one or more computing devices. Similarly, one or more of the communication manager 402, the collective tree generator 404, or the collective application manager 406 may represent software stored and configured to run on one or more computing devices, such as a server(s) 412. Any of the communication manager 402, the collective tree generator 404, and/or the collective application manager 406 in FIG. 4 may also represent all or portions of one or more special purpose computers to perform one or more operations.

As mentioned above, and as shown in FIG. 4, the tree-based collective optimization system 102 includes the communication manager 402. In one or more embodiments, the communication manager 402 receives data from physical compute nodes (e.g., the network endpoints 106a-106h) connected to the network switch 104. Additionally, the communication manager 402 transmits data to the physical compute nodes connected to the network switch 104. In at least one embodiment, the communication manager 402 receives and transmits data according to communication instructions included with the data. For example, the communication manager 402 can receive data from the network endpoint 106a that includes communication instructions telling the communication manager 402 to transmit that data to one or more specific additional network endpoints.

In some embodiments, the communication manager 402 also enables user-based communications. For example, in one or more implementations, certain configurations utilized by the tree-based collective optimization system 102 are user-specified. As such, the communication manager 402 can include input/output capabilities that enable a user to specify information such as an arity for a new collective tree and/or a number of nodes for a new collective tree.

As mentioned above, and as shown in FIG. 4, the tree-based collective optimization system 102 includes the collective tree generator 404. In one or more embodiments, the collective tree generator 404 generates collective trees in the same manner as described above with reference to FIGS. 3A-3G. For example, for any given number of nodes (N) and for any specified subtree arity (k), the collective tree generator 404 generates a collective tree by first setting aside p=(N−1) mod k nodes (e.g., setting aside a number of p-nodes). The collective tree generator 404 then builds a full k-ary initial subtree using the remaining N-p nodes as a breadth-first search subtree. Next, the collective tree generator 404 adds the p-nodes back into the initial subtree by selecting leaf nodes closest to the root, replacing those nodes with the p-nodes, and adding the replaced nodes back into the initial subtree as children of the p-nodes. Finally, the collective tree generator 404 generates a number of additional subtrees by rotating the first N-p nodes of the initial subtree such that index r_{old} is replaced by the node with index r_{new}=r_{old}+i*(N−1) mod k, where i is the index of the additional subtree starting from 1. The collective tree generator 404 generates the full collective tree by attaching all of the generated subtrees to the root node that was initially held back.

In a reduce collective, the root node represents the network endpoint requesting data from the other endpoints in the collective. In a broadcast collective, the root node represents the network endpoint that is transmitting data to all other endpoints in the collective. Regardless of the type of the collective tree, the collective tree generator 404 generates the collective tree such that, when applied to physical network endpoints, the collective tree causes the network endpoints to load-balance. In one or more embodiments, this load-balancing means that, when operating according to the logical network communication topology represented by the collective tree, each network endpoint has a number of outgoing flows and a number of incoming flows that are each no greater than the arity of the collective tree. Moreover, when the network endpoints operate according to the collective tree, the steps to complete a collective is no more than 2*logₖ(N), where N is the number of network endpoints (e.g., nodes) and k is the arity of the collective tree. This is significantly fewer steps than the steps it takes a ring-based collective to complete (i.e., 2*(N−1)).

As mentioned above, and as shown in FIG. 4, the tree-based collective optimization system 102 includes the collective application manager 406. In one or more embodiments, the collective application manager 406 applies the logical network communication topology represented by a collected tree to a number of network endpoints connected to a switch. For example, the collective application manager 406 can apply this logical network communication topology by generating communication instructions based on the collective tree. As discussed above, the collective tree effectively maps how each node communicates with other nodes.

To illustrate, in the quad 4-ary collective tree 314 illustrated in FIG. 3G, each node other than the root node 312 receives data from a number of nodes and transmits data to a number of nodes, as indicated by the directional arrows. As such, the collective application manager 406 can generate communication instructions from each of the connections indicated by the collective tree. The collective application manager 406 can further provide these instructions to each network endpoint to instruct each endpoint in how its data is to be transmitted. In at least one embodiment, and depending on the type of collective being performed, each network endpoint can generate its data for transmission including specific communication instructions that are based on the instructions given by the collective application manager 406. For example, a network endpoint can generate a data transmission including instructions for the network switch 104 that tell the network switch 104 to only pass that data transmission to one or more specified additional network endpoints. In this manner, the logical network communication topology represented by the collective tree is mapped or applied to the physical network endpoints attached to the network switch 104.

As further shown in FIG. 4, the network switch 104 can include additional items 410. In one or more embodiments, the additional items 410 can include data utilized by the tree-based collective optimization system 102 in generating and applying collective trees. For example, the additional items 410 can include user-specified information (e.g., an arity of a new collective tree). Additionally, the additional items 410 can include historical data such as previously generated collective trees. Furthermore, in some embodiments, the additional items 410 can include test data such as runtimes for previously applied collective trees and number of steps taken to complete previous collectives taken by various networking configurations.

In one or more embodiments, the network switch 104 can include one or more memories. For example, the one or more memories can generally represent any type or form of volatile or non-volatile storage device or medium capable of storing data and/or computer-readable instructions. In one example, the one or more memories may store, load, and/or maintain one or more components of the tree-based collective optimization system 102. Examples of the one or more memories can include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Additionally, as shown in FIG. 4, the network switch 104 can include one or more physical processors 408. The one or more processor(s) 408 generally represent any type or form of hardware-implemented processing units capable of interpreting and/or executing computer-readable instructions. In one implementation, the one or more physical processors 408 may access and/or modify one or more components of the tree-based collective optimization system 102. Examples of the one or more physical processors 408 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

FIG. 5 illustrates certain components that may be included within a computer system 500. One or more computer systems 500 may be used to implement the various devices, components, and systems described herein.

The computer system 500 includes a processor 501. The processor 501 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for optimizing load-balancing of a plurality of network endpoints comprising:
generating a collective tree representing a logical network communication topology for the plurality of network endpoints by:
identifying a plurality of nodes representing the plurality of network endpoints,
generating a first subtree of the collective tree as a breadth-first search subtree comprising the plurality of nodes according to an arity of the collective tree,
generating additional subtrees such that a total number of subtrees is equal to the arity of the collective tree by rotating the plurality of nodes from the first subtree such that any node in the plurality of nodes is a non-leaf node once across all subtrees of the collective tree, and
combining the first subtree and the additional subtrees; and
applying the logical network communication topology represented by the collective tree to the plurality of network endpoints to balance network communications such that each network endpoint has a number of outgoing flows no greater than the arity of the collective tree and a number of incoming flows no greater than the arity of the collective tree.

2. The method as recited in claim 1, wherein generating the collective tree further comprises, prior to generating the first subtree and the additional subtrees, setting aside a subset of the plurality of nodes based on the arity of the collective tree.

3. The method as recited in claim 2, wherein generating the collective tree further comprises, while generating the first subtree and the additional subtrees, inserting the subset of the plurality of nodes back into the first subtree and the additional subtrees by replacing existing leaves in the first subtree and the additional subtrees with the subset of the plurality of nodes and adding any replaced leaves back into the first subtree and the additional subtrees as children of the subset of the plurality of nodes.

4. The method as recited in claim 1, wherein generating the collective tree further comprises:
identifying a root node from the plurality of nodes based on a type of the collective tree; and
excluding the root node from generating the first subtree and the additional subtrees,
wherein combining the first subtree and the additional subtrees utilizes the root node.

5. The method as recited in claim 4, wherein the type of the collective tree comprises a reduce collective.

6. The method as recited in claim 4, wherein the type of the collective tree comprises a broadcast collective.

7. The method as recited in claim 1, wherein a number of steps to complete a collective among the plurality of network endpoints after the logical network communication topology represented by the collective tree is applied comprises two times a logarithm of a number of the plurality of network endpoints.

8. The method as recited in claim 1, wherein the arity of the collective tree is user-defined.

9. A system comprising:
at least one processor;
memory in electronic communication with the at least one processor; and
instructions stored in the memory, the instructions being executable by the at least one processor to:
generate a collective tree representing a logical network communication topology for a plurality of network endpoints by:
identifying a plurality of nodes representing the plurality of network endpoints,
generating a first subtree of the collective tree as a breadth-first search subtree comprising the plurality of nodes according to an arity of the collective tree,
generating additional subtrees such that a total number of subtrees is equal to the arity of the collective tree by rotating the plurality of nodes from the first subtree such that any node in the plurality of nodes is a non-leaf node once across all subtrees of the collective tree, and
combining the first subtree and the additional subtrees; and
apply the logical network communication topology represented by the collective tree to the plurality of network endpoints to balance network communications such that each network endpoint has a number of outgoing flows no greater than the arity of the collective tree and a number of incoming flows no greater than the arity of the collective tree.

10. The system as recited in claim 9, further storing instructions being executable by the at least one processor to further generate the collective tree by, prior to generating the first subtree and the additional subtrees, setting aside a subset of the plurality of nodes based on the arity of the collective tree.

11. The system as recited in claim 10, further storing instructions being executable by the at least one processor to further generate the collective tree by, while generating the first subtree and the additional subtrees, inserting the subset of the plurality of nodes back into the first subtree and the additional subtrees by replacing existing leaves in the first subtree and the additional subtrees with the subset of the plurality of nodes and adding any replaced leaves back into the first subtree and the additional subtrees as children of the subset of the plurality of nodes.

12. The system as recited in claim 9, further storing instructions being executable by the at least one processor to further generate the collective tree by:
identifying a root node from the plurality of nodes based on a type of the collective tree; excluding the root node from generating the first subtree and the additional subtrees;
wherein combining the first subtree and the additional subtrees utilizes the root node.

13. The system as recited in claim 12, wherein the type of the collective tree comprises a reduce collective.

14. The system as recited in claim 12, wherein the type of the collective tree comprises a broadcast collective.

15. The system as recited in claim 12, wherein a number of steps to complete a collective among the plurality of network endpoints after the logical network communication topology represented by the collective tree is applied comprises two times a logarithm of a number of the plurality of network endpoints.

16. The system as recited in claim 12, wherein the arity of the collective tree is user-defined.

17. A non-transitory computer-readable medium comprising instructions that when executed by one or more processors causes one or more computing devices to:
generate a collective tree representing a logical network communication topology for a plurality of network endpoints by:
identifying a plurality of nodes representing the plurality of network endpoints,
generating a first subtree of the collective tree as a breadth-first search subtree comprising the plurality of nodes according to an arity of the collective tree,
generating additional subtrees such that a total number of subtrees is equal to the arity of the collective tree by rotating the plurality of nodes from the first subtree such that any node in the plurality of nodes is a non-leaf node once across all subtrees of the collective tree, and
combining the first subtree and the additional subtrees; and
apply the logical network communication topology represented by the collective tree to the plurality of network endpoints to balance network communications such that each network endpoint has a number of outgoing flows no greater than the arity of the collective tree and a number of incoming flows no greater than the arity of the collective tree.

18. The non-transitory computer-readable medium as recited in claim 17, further comprising instructions that when executed by the one or more processors causes the one or more computing devices to further generate the collective tree by:
prior to generating the first subtree and the additional subtrees, setting aside a subset of the plurality of nodes based on the arity of the collective tree; and
while generating the first subtree and the additional subtrees, inserting the subset of the plurality of nodes back into the first subtree and the additional subtrees by replacing existing leaves in the first subtree and the additional subtrees with the subset of the plurality of nodes and adding any replaced leaves back into the first subtree and the additional subtrees as children of the subset of the plurality of nodes.

19. The non-transitory computer-readable medium as recited in claim 17, further comprising instructions that when executed by the one or more processors causes the one or more computing devices to further generate the collective tree by:
identifying a root node from the plurality of nodes based on a type of the collective tree;
excluding the root node from generating the first subtree and the additional subtrees;
wherein combining the first subtree and the additional subtrees utilizes the root node.

20. The non-transitory computer-readable medium as recited in claim 17, wherein a number of steps to complete a collective among the plurality of network endpoints after the logical network communication topology represented by the collective tree is applied comprises two times a logarithm of a number of the plurality of network endpoints.
